(19) United States
(12) Patent Application Publication
(10) Pub. No.: US 2018/0190061 A1
(43) Pub. Date: Jul. 5, 2018

(54) TRANSACTION DEVICE

(71) Applicant: Oki Electric Industry Co., Ltd., Tokyo (JP)

(72) Inventor: Hiroyuki SAKAI, Tokyo (JP)

(73) Assignee: Oki Electric Industry Co., Ltd., Tokyo (JP)

(21) Appl. No.: 15/738,571

(22) PCT Filed: Jun. 16, 2016
(86) PCT No.: PCT/JP2016/068006

§ 371 Date: Dec. 20, 2017

(30) Foreign Application Priority Data
Jul. 24, 2015 (JP) 2015-146959

(51) Int. Cl. G07F 7/10; G07F 19/00

(52) U.S. Cl. CPC G07F 7/1016; G07F 19/206; G07F 7/1083; G07F 7/1033

(57) ABSTRACT

A transaction device includes an input section, a determination unit, a recording section, and a transaction processor. The input section includes plural keys. The determination unit monitors for one out of a simultaneous-pressing state in which plural of the keys are pressed at the same time or an extended-pressing state in which one of the keys is pressed continuously for a predetermined duration or longer, and determines that improper input has been performed in cases in which either a simultaneous-pressing state or an extended-pressing state has been detected. The recording section records setting information indicating processing contents for when the determination unit has determined that improper input has been performed. The transaction processor performs transaction processing with a customer using the input section, and performs an action according to setting information recorded in the recording section when the determination unit has determined that improper input has been performed.

### TECHNICAL FIELD

The present invention relates to a transaction device, and may, for example, be applied to an Automated Teller Machine (ATM) installed in a financial institution, convenience store, or the like.

### BACKGROUND ART

ATMs exist in which a device provided with both physical keys (for example function keys) and a display that displays operation screens (for example a GUI including on-screen keys) is employed as a user interface (see Japanese Patent Application Laid-Open (JP-A) No. 2002-32833 (Patent Document 1)).

In related ATMs, during a customer transaction, for example, input of information such as a PIN and a transaction amount is accepted through on-screen keys displayed on a touch panel display (for example a ten-key displayed on an operation screen), and through physical keys (for example a physical ten-key such as a PIN pad).

### SUMMARY OF INVENTION

### Technical Problem

In related ATMs, when accepting numerical input such as a PIN or a transaction amount, both the on-screen keys (touch panel display) and physical keys start accepting input at the same time. Moreover, usually in related ATMs, if input is performed using both the on-screen keys and the physical keys, a state in which input is disabled (a state in which the keys do not respond even if pressed) is adopted. As a result, in related ATMs, if input is performed using both on-screen keys and physical keys, the device on which input was started later elicits no response from the operation screen when operated.

Accordingly, for example in a situation in which a third party planning to make a fraudulent transaction targeting a genuine user presses either an on-screen key or a physical key (function key), a state is adopted in which the keys elicit no response even when the keys are pressed by the genuine user. In such cases, the ATM adopts a state that appears unresponsive, the keys eliciting no response even when the keys are pressed by the genuine user. When such a state arises, the third party planning a fraudulent transaction may be able to persuade the genuine user to go and report to a bank employee that the ATM has developed a fault. While the genuine user is away from the scene, the third party planning a fraudulent transaction is then able to input a new payment amount, take the cash, and complete a payment transaction. Moreover, if the genuine user leaves the side of the ATM leaving their card or passbook still inserted therein, it is possible that a malicious party may steal the card or passbook.

On the other hand, in cases in which simultaneous input using both on-screen keys and physical keys is possible, it is possible that a customer could input unintended numbers as a result of incorrect operation, causing inconvenience.

In consideration of the above circumstances, a transaction device (such as an ATM) that improves transaction safety (security) when accepting input using plural keys is desirable.

### Solution to Problem

A transaction device of the present invention includes: (1) an input section including plural keys; (2) a determination means that monitors for at least one out of a simultaneous-pressing state in which plural of the keys are pressed at the same time or an extended-pressing state in which one of the keys is pressed continuously for a predetermined duration or longer, and that determines that improper input has been performed in cases in which either a simultaneous-pressing state or an extended-pressing state has been detected; (3) a recording section that records setting information indicating processing contents for cases in which the determination means has determined that improper input has been performed; and (4) a transaction processing means that performs transaction processing with a customer using the input section, and that performs an action according to setting information recorded in the recording section in cases in which the determination means has determined that improper input has been performed.

### Advantageous Effects of Invention

The present invention is capable of providing a transaction device that improves transaction safety when accepting input using plural keys.

### BRIEF DESCRIPTION OF DRAWINGS

FIG. 1 is a block diagram illustrating functional configuration of an ATM according to a first exemplary embodiment.

FIG. 2A is a perspective view illustrating an ATM according to the first exemplary embodiment, as viewed from a front face side.

FIG. 2B is a diagram (back face view) illustrating an ATM according to the first exemplary embodiment, as viewed from a back face side.

FIG. 3 is a plan view of a PIN pad configuring an ATM according to the first exemplary embodiment.

FIG. 4 is an explanatory diagram illustrating an example of configuration of key settings information according to the first exemplary embodiment.

FIG. 5 is a flowchart illustrating operation during key settings information input processing according to the first exemplary embodiment.

FIG. 6 is an explanatory diagram illustrating an example of configuration of an improper input response setting value input screen displayed on an ATM according to the first exemplary embodiment.

FIG. 7 is a flowchart illustrating operation in a case in which a pay-out transaction is performed as an automated transaction according to the first exemplary embodiment.

FIG. 8 is an explanatory diagram illustrating an example of configuration of a pay-out amount input screen displayed on an ATM according to the first exemplary embodiment.

FIG. 9 is an explanatory diagram illustrating an example of configuration of key settings information according to a second exemplary embodiment.

FIG. 10 is a flowchart illustrating operation during key settings information input processing according to the second exemplary embodiment.

FIG. 11 is an explanatory diagram illustrating an example of configuration of a time of day input screen displayed on an ATM according to the second exemplary embodiment.

FIG. 12 is a flowchart illustrating operation in a case in which a pay-out transaction is performed as an automated transaction according to the second exemplary embodiment.

FIG. 13 is an explanatory diagram illustrating an example of configuration of key settings information according to a third exemplary embodiment.

FIG. 14 is a flowchart illustrating operation during key settings information input processing according to the third exemplary embodiment.

FIG. 15 is an explanatory diagram illustrating an example of configuration of an acknowledgement screen setting value input screen according to the third exemplary embodiment.

FIG. 16 is a flowchart illustrating operation in a case in which a pay-out transaction is performed as an automated transaction according to the third exemplary embodiment.

FIG. 17 is an explanatory diagram illustrating an example of configuration of an improper input acknowledgement screen displayed on an ATM according to the third exemplary embodiment.

FIG. 18 is a block diagram illustrating functional configuration of an ATM according to a fourth exemplary embodiment.

FIG. 19 is a diagram illustrating the exterior of an ATM according to the fourth exemplary embodiment in perspective view.

FIG. 20 is an explanatory diagram illustrating an example of configuration of key settings information according to the fourth exemplary embodiment.

FIG. 21 is a flowchart illustrating operation during key settings information input processing according to the fourth exemplary embodiment.

FIG. 22 is an explanatory diagram illustrating an example of configuration of a warning sound setting value input screen according to the fourth exemplary embodiment.

FIG. 23 is an explanatory diagram illustrating an example of configuration of a warning message setting value input screen according to the fourth exemplary embodiment.

FIG. 24 is an explanatory diagram illustrating an example of configuration of a blinker lamp setting value input screen according to the fourth exemplary embodiment.

FIG. 25 is a flowchart (part 1) illustrating operation in a case in which a pay-out transaction is performed as an automated transaction according to the fourth exemplary embodiment.

FIG. 26 is a flowchart (part 2) illustrating operation in a case in which a pay-out transaction is performed as an automated transaction according to the fourth exemplary embodiment.

FIG. 27 is a perspective view illustrating the exterior of an ATM according to a modified example of the first exemplary embodiment.

FIG. 28 is an explanatory diagram illustrating an example of an operation screen displayed on a display and operation section according to a modified example of the first exemplary embodiment.

### DESCRIPTION OF EMBODIMENTS

### (A) First Exemplary Embodiment

Detailed explanation follows regarding a first exemplary embodiment of a transaction device according to the present invention, with reference to the drawings. The following explanation gives an example in which the transaction device of the present invention is applied to an ATM.

### (A-1) Configuration of First Exemplary Embodiment

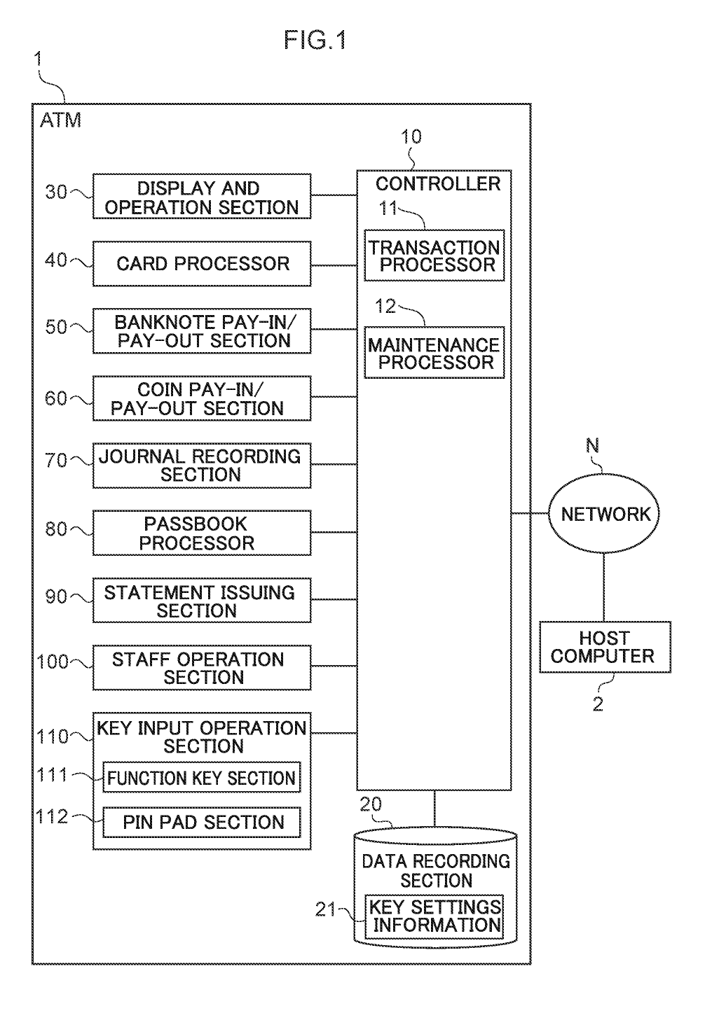

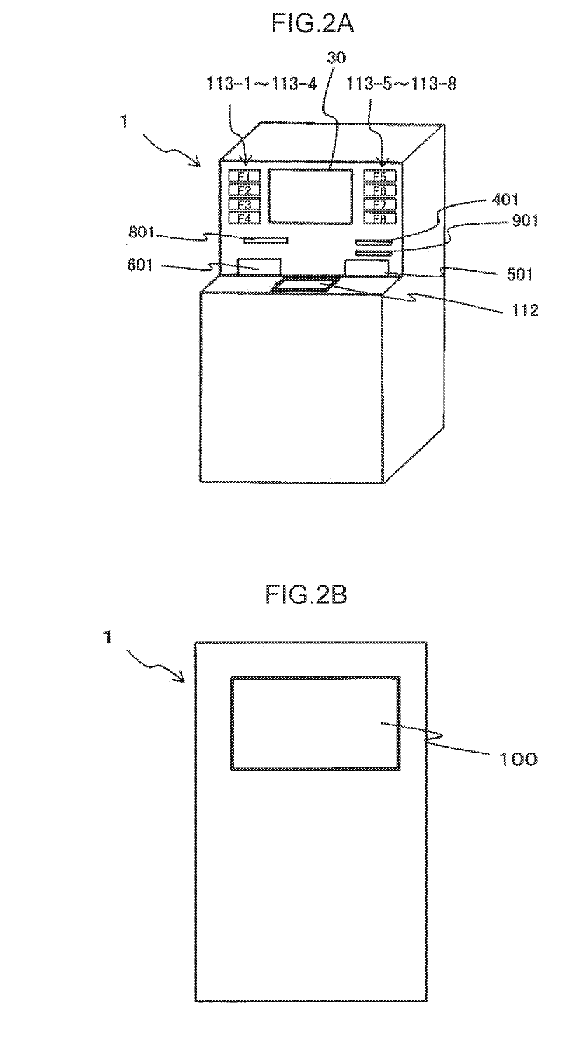

FIG. 1 is a block diagram illustrating functional configuration and the configuration of a connection to a peripheral device in an ATM 1 of the first exemplary embodiment. FIG. 2A and FIG. 2B are diagrams illustrating the exterior of the ATM 1. FIG. 2A is a perspective view of the ATM 1 as viewed from a front face side. FIG. 2B is a diagram (back face view) illustrating the ATM 1 as viewed from a back face side.

The ATM 1 performs transaction processing with a customer (for example to withdraw cash from a customer's account) as a result of customer operation to perform transaction processing and coordinated processing (for example processing in a transaction) involving communication with a host computer 2.

The ATM 1 is connected to the host computer 2 through a network N. Various network connections, such as public telecommunications networks, dedicated digital lines, or the Internet may be applied as the network N.

The ATM 1 includes a controller 10, a data recording section 20 serving as a recording section, a display and operation section 30, a card processor 40, a banknote pay-in/pay-out section 50, a coin pay-in/pay-out section 60, a journal recording section 70, a passbook processor 80, a statement issuing section 90, a staff operation section 100, and a key input operation section 110.

The controller 10 has a function of controlling the operation of each section of the ATM 1. The data recording section 20 is a data storage means that stores various information required in order for the controller 10 to perform information processing, and is, for example, configured by memory of various types. Note that the data recording section 20 of the present exemplary embodiment records at least key settings information 21, serving as setting information. Detailed explanation of the data recording section 20 will be given later.

The controller 10 may, for example, be implemented by installing a control program of an exemplary embodiment (including a program relating to each configuration element within the controller 10 illustrated in FIG. 1) on a program-implementing configuration (computer) including a processor and the like. The program may, for example, be stored in the data recording section 20, and be read and executed by the controller 10 when the ATM 1 is started up.

The display and operation section 30 is a device configuring a customer interface, and is configured by a touch panel display (a liquid crystal display incorporated with a touch panel) in this example. The display and operation section 30 displays operation screens according to control by the controller 10, and is capable of outputting information and receiving operation (receiving input of information). In other words, the display and operation section 30 functions as a display section that outputs display to the customer (for example outputting display of transaction details and the like), and implements some of the functionality of an input section that receives operation from a customer (for example operation using on-screen keys). The specific configuration of the device is not particularly limited.

The card processor 40 processes a cash card inserted into a card insertion/removal port 401 by a customer.

The banknote pay-in/pay-out section 50 has a function of storing banknotes paid in by a customer and has a function of paying out stored banknotes to a customer under the control of the controller 10. In the present exemplary embodiment, the banknote pay-in/pay-out section 50 is capable of performing pay-in and pay-out of banknotes via a banknote pay-in/pay-out port 501.

The coin pay-in/pay-out section 60 has a function of storing coins paid in by a customer and has a function of paying out stored coins to a customer under the control of the controller 10. In the present exemplary embodiment, the coin pay-in/pay-out section 60 is capable of performing pay-in and pay-out of coins via a coin pay-in/pay-out port 601.

The journal recording section 70 performs processing to make a printed record of transaction details on a journal sheet (for example on a paper roll) under the control of the controller 10.

The passbook processor 80 processes a passbook inserted into a passbook insertion/removal port 801 by a customer.

The statement issuing section 90 prints the outcome of a transaction performed by the ATM 1 on printing paper and dispenses this through a statement dispensing port 901 under the control of the controller 10.

The staff operation section 100 is a device configuring an interface with the staff of a shop where the ATM 1 is installed, maintenance technicians, or the like (referred to below as “operators”). In this example, the staff operation section 100 is configured by a touch panel display (a liquid crystal display incorporated with a touch panel). The staff operation section 100 is capable of displaying operation screens, outputting information, and receiving operation (receiving input of information) under the control of the controller 10. In other words, the staff operation section 100 functions as an operator display section that outputs display to the operator (for example outputting display of transaction details and the like), and functions as an operator operation section that receives operation from the operator. The specific configuration of the device is not particularly limited. Although there is no limitation to the placement of the staff operation section 100, the staff operation section 100 is usually placed at a position that can only be accessed by an operator (for example behind a locked door, not illustrated in the drawings). In the example of the staff operation section 100 of the present exemplary embodiment, the staff operation section 100 is disposed at the back face side of the ATM 1, as illustrated in FIG. 2B. Moreover, in the present exemplary embodiment, explanation is given in which the display and operation section 30 and the staff operation section 100 are configured by separate devices. However, configuration may be made employing a common device that can be switched between customer-use and operator-use running modes.

The key input operation section 110 receives input of operation from the customer through physical keys. There is no limitation to the number and placement of the physical keys configuring the key input operation section 110, nor to the functions of each physical key. The key input operation section 110 of the present exemplary embodiment includes a function key section 111 and a PIN pad section 112.

The function key section 111 includes plural physical keys (referred to below as “function keys”) that are allocated to functions performed under the control of the controller 10. In the present exemplary embodiment, the function key section 111 includes eight function keys 113-1 to 113-8. In the present exemplary embodiment, as illustrated in FIG. 2A, the function keys 113-1 to 113-4 are disposed on the left side of the display and operation section 30, and the function keys 113-5 to 113-8 are disposed on the right side of the display and operation section 30. The controller 10 (transaction processor 11) allocates functions appropriate to the configuration of an operation screen displayed on the display and operation section 30 to the respective function keys 113, and receives customer operation.

The PIN pad section 112 is a device provided with physical keys capable of receiving numerical input, such as PINs and transaction amounts.

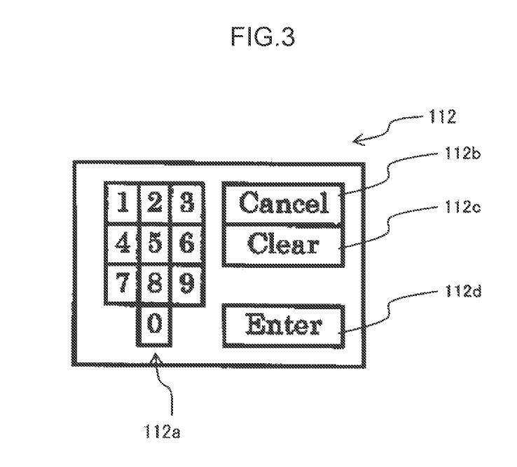

FIG. 3 is a plan view of the PIN pad section 112.

A ten-key section 112a including physical keys corresponding to each of the numbers 0 to 9, a Cancel key 112b, a Clear key 112c, and an Enter key 112d are disposed on the PIN pad section 112 illustrated in FIG. 3. The controller 10 (transaction processor 11) receives input of operation appropriate to the configuration of an operation screen displayed on the display and operation section 30 through the respective keys of the PIN pad section 112.

As described above, the ATM 1 is configured with an input section that receives customer input (input using the plural keys) through the configuration including the display and operation section 30 that is capable of displaying operation screens having on-screen keys and the key input operation section 110 that is configured by physical keys.

The transaction processor 11 performs processing relating to customer transactions. For example, the transaction processor 11 receives operation via the display and operation section 30 and the key input operation section 110 (for example receiving operation performed using an operation screen), performs data processing (such as transaction processing relating to transactions) with the host computer 2 based on information input by a customer, and performs cash processing control processing and the like involving the banknote pay-in/pay-out section 50 and the coin pay-in/pay-out section 60.

The transaction processor 11 performs processing to detect improper input in operations in cases in which predetermined operations (operations in which there is a high likelihood of improper input) have been performed using the on-screen keys displayed on the display and operation section 30 or the physical keys of the staff operation section 100. For example, when receiving input of a transaction amount or the like, the transaction processor 11 determines improper input (for example pressing of a key by a third party other than a customer) to have taken place in cases in which either plural keys (there is no limitation as to whether these are physical keys or on-screen keys) are pressed at the same time (such a state is also referred to below as a “simultaneous-pressing state”), or when one key is pressed continuously for a predetermined duration or longer (for example, for 5 seconds or longer) (such a state is also referred to below as an “extended-pressing state”). Namely, the transaction processor 11 also functions as determination means that detects improper input.

Moreover, in cases in which improper input has been detected, the transaction processor 11 of the present exemplary embodiment performs predetermined actions according to the settings of the key settings information 21 recorded in the data recording section 20.

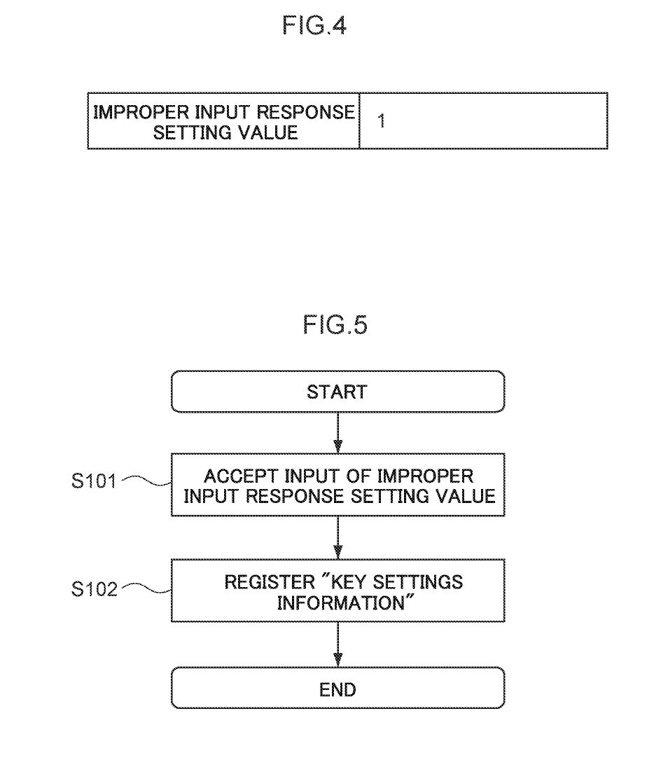

FIG. 4 is an explanatory diagram illustrating an example of configuration of the key settings information 21 according to the first exemplary embodiment.

In the key settings information 21 illustrated in FIG. 4, a value (parameter) is set under the heading “improper input response setting value”. The “improper input response setting value” is a heading that is set with a value indicating contents of an action to be performed by the transaction processor 11 when improper input has been detected.

In the present exemplary embodiment, explanation is given in which the “improper input response setting value” is set to either 1, 2, or 3. Note that there is no limitation to the number of processing types corresponding to “improper input response setting value” values, nor to the contents of processing corresponding to the respective setting values.

In the present exemplary embodiment, in cases in which the improper input response setting value of the key settings information 21 is set to “1”, the transaction processor 11 does not do anything (and also disables any input using other keys) until the improper input has been released (for example, until the simultaneous-pressing state or the extended-pressing state has been released).

Moreover, in the present exemplary embodiment, in cases in which the improper input response setting value of the key settings information 21 is set to “2”, the transaction processor 11 performs processing to cancel (interrupt) the transaction currently underway (for example, the same processing is performed as when a key to cancel (cancel key) is pressed; this is also referred to below as “transaction cancellation”).

Moreover, in the present exemplary embodiment, in cases in which the improper input response setting value of the key settings information 21 is set to “3”, the transaction processor 11 performs processing to terminate the transaction as if an abnormality had arisen (also referred to below as “abnormal transaction termination”). When abnormal transaction termination is performed, the controller 10 (transaction processor 11) adopts a state in which no subsequent transactions are received. Moreover, when abnormal transaction termination is performed, the controller 10 (transaction processor 11) may notify an external device (an external device such as the host computer or a monitoring device) with an alarm (warning), and perform processing to call a member of staff.

A maintenance processor 12 functions to execute processing relating to (system) maintenance of the ATM 1. For example, the maintenance processor 12 receives operation via the staff operation section 100 (for example, receives operation using an operation screen), and executes processing according to the received operation. The maintenance processor 12 of the present exemplary embodiment at least functions as a setting changing means that accepts changes to the key settings information 21.

Note that the maintenance processor 12 may accept changes to the key settings information 21 through communication from an external device (such as the host computer 2) as well as through operation by an operator.

### (A-2) Operation of the First Exemplary Embodiment

Next, explanation follows regarding operation of the ATM 1 of the first exemplary embodiment configured as described above.

First, explanation is given regarding operation when setting the key settings information 21 of the ATM 1 of the first exemplary embodiment, with reference to FIG. 5.

First, the staff operation section 100 of the ATM 1 receives operation from an operator so as to select processing to accept input (changes) to the key settings information 21 (referred to below as “key setting”). The maintenance processor 12 of the controller 10 accordingly starts processing to accept key setting, and displays on the staff operation section 100 an operation screen (referred to below as the “improper input response setting value input screen”) to accept the improper input response setting value configuring the key settings information 21 (S101).

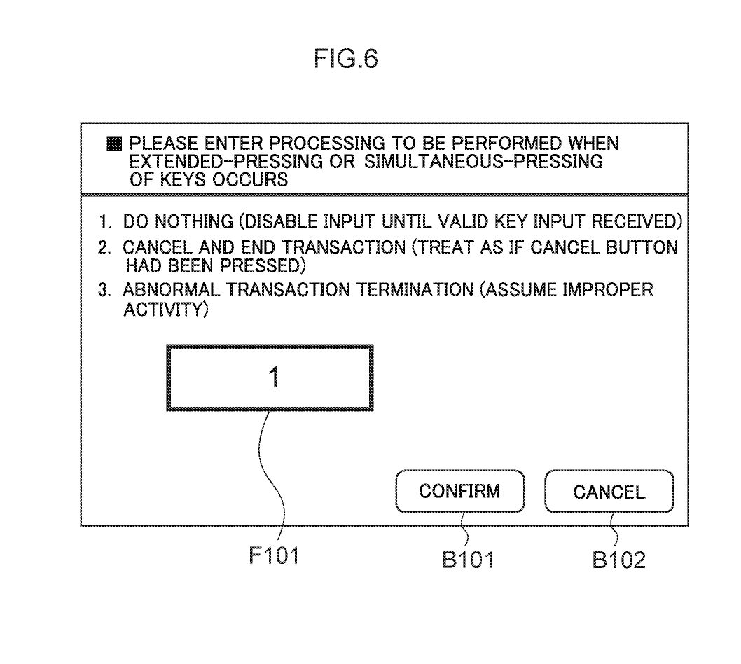

FIG. 6 is an explanatory diagram illustrating an example of the improper input response setting value input screen.

A field F101 that accepts input of the improper input response setting value (either 1, 2, or 3), a “Confirm” key B101 that accepts confirmation of the improper input response setting value input to the field F101, and a “Cancel” key B102 that cancels the improper input response setting value that has been input and returns to a previous screen or the like (for example, a function selection menu) are arranged on the improper input response setting value input screen illustrated in FIG. 6. On the improper input response setting value input screen illustrated in FIG. 6, the “Confirm” key B101 is pressed after the setting value has been input to the field F101.

When the “Confirm” key B101 of the improper input response setting value input screen is pressed, the maintenance processor 12 of the controller 10 acquires the improper input response setting value that has been input, registers the improper input response setting value as the key settings information 21 of the data recording section 20 (S102), and ends processing.

The ATM 1 of the first exemplary embodiment registers the contents of the key settings information 21 in the manner described above.

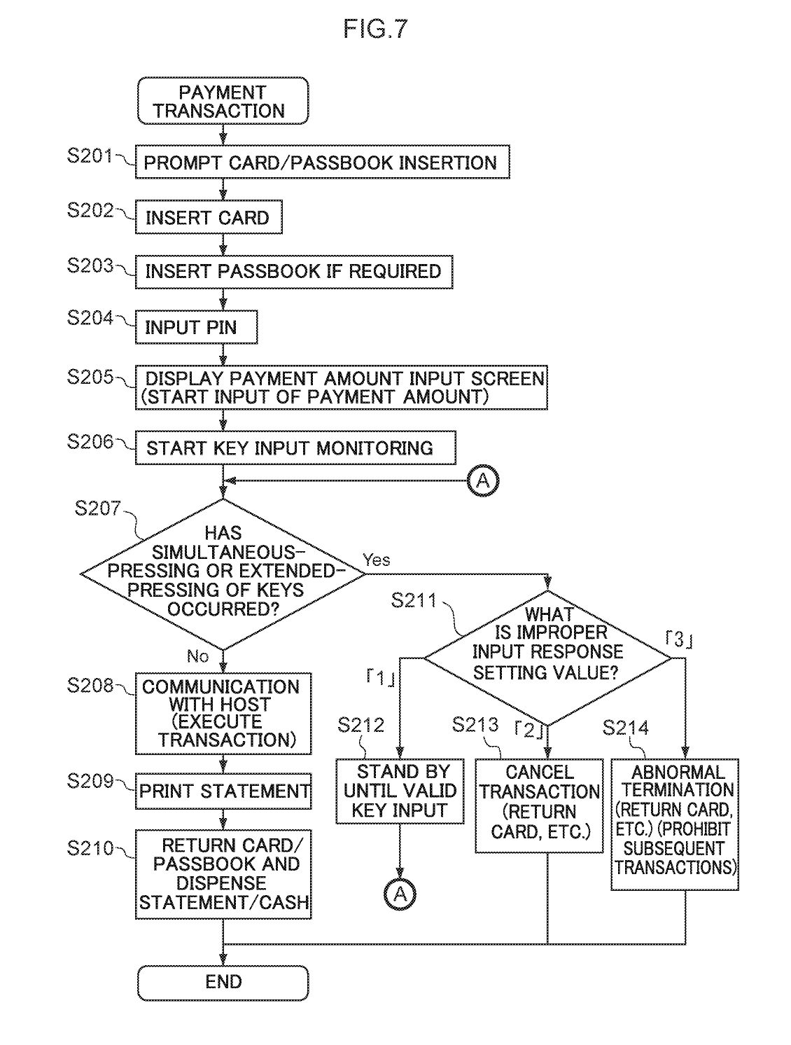

Next, explanation follows regarding examples of processing performed when the ATM 1 performs a customer transaction, with reference to the flowchart in FIG. 7.

First, a pay-out transaction is started by customer operation (operation of the display and operation section 30) from a customer-awaiting state of the ATM 1, and an operation screen prompting insertion of a cash card or passbook is displayed on the display and operation section 30 (S201).

Next, the customer inserts a cash card into the card insertion/removal port 401 (S202).

When this is performed, according to the customer's requirements, the customer may also insert a passbook into the passbook insertion/removal port 801 (S203).

Next, the controller 10 (transaction processor 11) displays an operation screen that accepts input of a PIN on the display and operation section 30, and accepts input of a PIN by the customer (S204).

Next, the controller 10 (transaction processor 11) displays an operation screen that accepts input of a pay-out amount (transaction amount) (referred to below as a “transaction amount input screen”) on the display and operation section 30, and accepts input of a pay-out amount by the customer (S205).

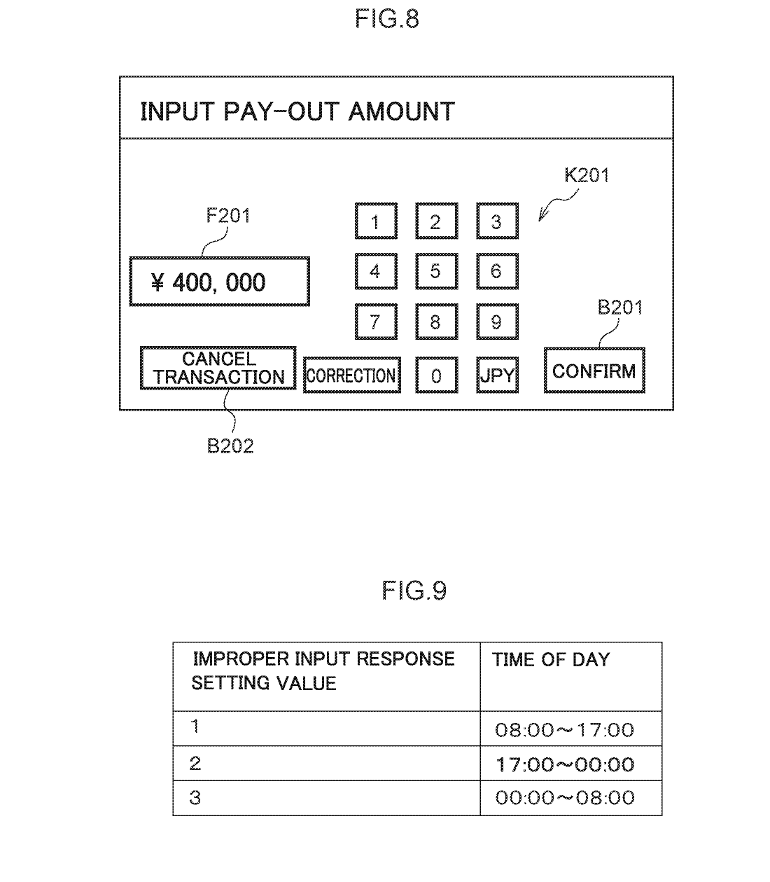

FIG. 8 is an explanatory diagram illustrating an example of configuration of a pay-out amount input screen. A on-screen keypad K201 for inputting a pay-out amount, a field F201 that displays the input pay-out amount, a “Confirm” key B201 that accepts confirmation in order to continue with the transaction using the input pay-out amount, and a “Cancel” key B202 that terminates the transaction are arranged on the pay-out amount input screen illustrated in FIG. 8. The on-screen keypad K201 is configured by keys displaying the digits 0 to 9, “WY”, and “Correction”. Note that in a state in which the controller 10 (transaction processor 11) is displaying the pay-out amount input screen, the controller 10 (transaction processor 11) performs control in a state in which input can be accepted from the PIN pad section 112 as well as through the on-screen keys on the pay-out amount input screen.

When the transaction amount input screen is displayed, the controller 10 (transaction processor 11) begins monitoring for the presence or absence of simultaneous-pressing and extended-pressing (S206).

Then, when the pay-out amount input screen is being displayed, the controller 10 (transaction processor 11) determines its subsequent actions according to whether or not simultaneous-pressing or extended-pressing occurred while monitoring for the presence or absence of simultaneous-pressing and extended-pressing (S207). In cases in which simultaneous-pressing or extended-pressing did occur, the controller 10 (transaction processor 11) transitions to the processing of step S211, described later. On the other hand, in cases in which input of the transaction amount was completed without the occurrence of simultaneous-pressing or extended-pressing, the controller 10 (transaction processor 11) transitions to the processing of step S208, described later.

In cases in which input of the transaction amount was completed without the occurrence of simultaneous-pressing or extended-pressing, the controller 10 (transaction processor 11) communicates with the host computer 2 and executes information processing (for example, transaction processing) relating to the pay-out transaction (S208). The following explanation assumes a case in which pay-out transaction processing between the controller 10 (transaction processor 11) and the host computer 2 was successful.

Next, the controller 10 (transaction processor 11) controls the statement issuing section 90 so as to print a statement for the current pay-out transaction (S209).

Next, the controller 10 (transaction processor 11) performs control processing to dispense (return) various media (S210), and ends the transaction processing. When this is performed, the controller 10 (transaction processor 11) controls the statement issuing section 90 so as to dispense the printed statement. The controller 10 (transaction processor 11) also controls the card processor 40 so as to return (dispense) the cash card. In cases in which a passbook has been inserted, the controller 10 (transaction processor 11) also controls the passbook processor 80 so as to return (dispense) the passbook after performing processing to update the records in the passbook. Moreover, the controller 10 (transaction processor 11) controls the banknote pay-in/pay-out section 50 and the coin pay-in/pay-out section 60 so as to dispense cash to be paid out in the current pay-out transaction.

On the other hand, in cases in which simultaneous-pressing or extended-pressing occurred while the transaction amount input screen was being displayed at step S207 described above, the controller 10 (transaction processor 11) references the key settings information 21 to confirm the improper input response setting value (S211). Then, the controller 10 (transaction processor 11) transitions to step S212, described later, in cases in which the improper input response setting value is “1”, transitions to step S213, described later, in cases in which the improper input response setting value is “2”, and transitions to step S214, described later, in cases in which the improper input response setting value is “3”.

In cases in which the improper input response setting value is “1”, the controller 10 (transaction processor 11) stands by without doing anything until the improper input has been released (for example, until the simultaneous-pressing state or the extended-pressing state has been released) (and also disables any input using other keys) (S212). The controller 10 (transaction processor 11) returns to operation according to the processing of step S207 described above after the simultaneous-pressing or extended-pressing has been released.

In cases in which the improper input response setting value is “2”, the controller 10 (transaction processor 11) cancels the transaction (interrupts the transaction and returns the cash card, passbook, and the like) (S213), and then ends the current transaction processing.

In cases in which the improper input response setting value is “3”, the controller 10 (transaction processor 11) operates such that the transaction processor 11 identifies improper activity as having occurred, and performs processing to terminate the transaction as if an abnormality had arisen (abnormal transaction termination) (S214), and then ends the current transaction processing.

### (A-3) Advantageous Effects of the First Exemplary Embodiment

The first exemplary embodiment is capable of exhibiting the following advantageous effects.

In the ATM 1 of the first exemplary embodiment, in cases in which operation that has a high likelihood of being improper key input by a third party (for example simultaneous-pressing or extended-pressing of keys) has occurred, action is taken according to the key settings information 21, thereby preventing improper activity (for example, preventing fraudulent payment transactions from a customer's account). The ATM 1 of the first exemplary embodiment is thereby capable of taking action (responding) according to the installation environment in cases in which improper key operation has occurred. For example, when an ATM 1 is installed in a shop in which staff are present (staffed shop), a member of staff can attend straight away. Accordingly, by setting the improper input response setting value to “3” (abnormal termination), for example, improper input can be reliably suppressed and transactions can be restarted immediately (for example, by restarting the device). On the other hand, when an ATM 1 is installed in a shop in which staff are not present (unstaffed shop), although it is not possible for a member of staff to attend straight away, for example by setting the improper input response setting value to “2” (transaction cancellation), improper input can be suppressed while allowing transactions to be continued.

As described above, the ATM 1 of the first exemplary embodiment provides a transaction device that improves transaction safety during a transaction while suppressing a reduction in customer convenience when accepting input using plural input keys.

### (B) Second Exemplary Embodiment

Detailed explanation follows regarding a second exemplary embodiment of a transaction device of the present invention, with reference to the drawings. In the following, explanation is given regarding an example in which a transaction device of the present invention is applied to an ATM.

### (B-1) Configuration of the Second Exemplary Embodiment

The configuration of an ATM 1 of the second exemplary embodiment can also be illustrated using FIG. 1, FIG. 2A, and FIG. 2B described above. The following explanation concerns differences between the ATM 1 of the second exemplary embodiment and that of the first exemplary embodiment.

In the ATM 1 of the first exemplary embodiment, as illustrated in FIG. 4, the contents of the key settings information 21 only allow the improper input response setting value to be set to a single value (a setting value of either 1, 2, or 3). Namely, in the ATM 1 of the first exemplary embodiment, the improper input response setting value is a static value. By contrast, the ATM 1 of the second exemplary embodiment enables the improper input response setting value to actively change according to the time of day.

FIG. 9 is an explanatory diagram illustrating an example of configuration of key settings information 21 set in the ATM 1 of the second exemplary embodiment.

As illustrated in FIG. 9, the key settings information 21 of the second exemplary embodiment enables registration of combinations of times of day and improper input response setting values. Specifically, in the key settings information 21 illustrated in FIG. 9, applicable times of day are set for each setting value. In the key settings information 21 illustrated in FIG. 9, the time of day corresponding to the improper input response setting value of “1” is set to “08:00 to 17:00”, the time of day corresponding to the improper input response setting value of “2” is set to “17:00 to 00:00”, and the time of day corresponding to the improper input response setting value of “3” is set to “00:00 to 08:00”.

The key settings information 21 illustrated in FIG. 9 illustrates an example in which combinations of times of day and setting values are registered. However, configuration may be such that it is possible to set combinations of periods of time such as specific dates and times, or days of the week, and setting values (a schedule applied to setting values). Moreover, although the key settings information 21 in FIG. 9 has a format in which the time of day is input for each improper input response setting value, conversely, configuration may be made using a format in which an improper input response setting value is set for each time of day.

### (B-2) Operation of the Second Exemplary Embodiment

Next, explanation follows regarding operation of the ATM 1 of the second exemplary embodiment configured as described above.

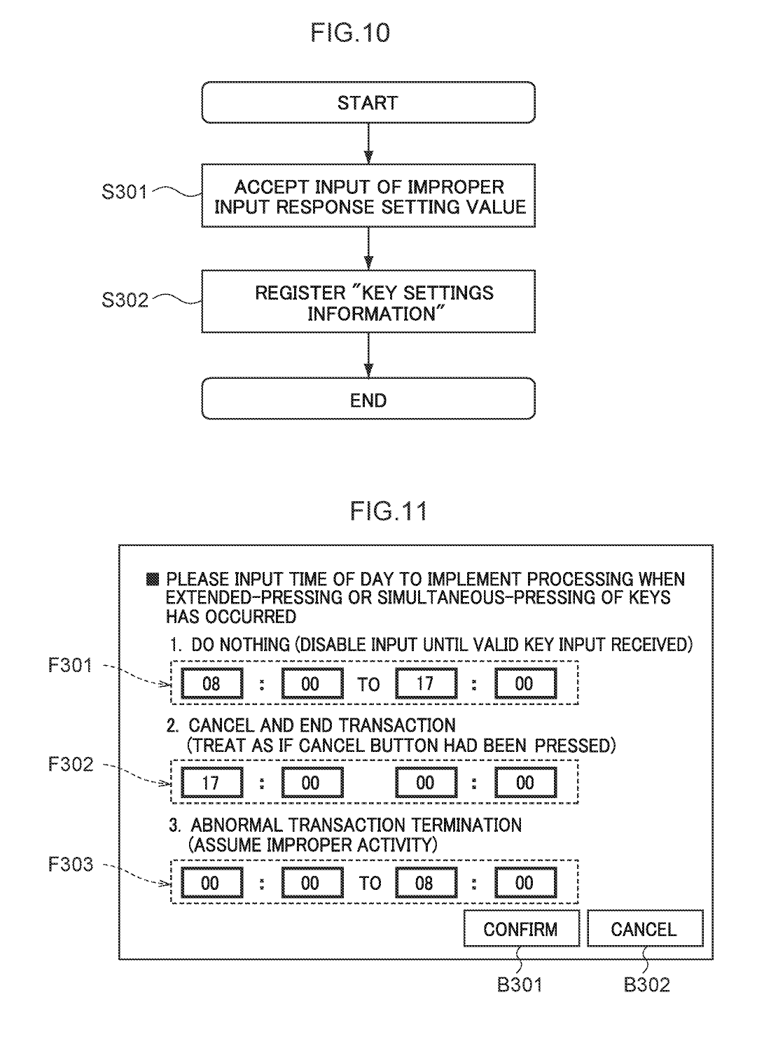

First, explanation follows regarding operation when setting the key settings information 21 of the ATM 1 of the second exemplary embodiment, with reference to FIG. 10.

First, the staff operation section 100 of the ATM 1 accepts operation to select key settings from an operator. When key settings have been selected, the maintenance processor 12 of the controller 10 displays on the staff operation section 100 an operation screen (referred to below as the “time of day input screen”) that accepts input of a time of day for each improper input response setting value configuring the key settings information 21 (S301).

FIG. 11 is an explanatory diagram illustrating an example of configuration of the time of day input screen of the second exemplary embodiment.

Fields F301 to F303 that accept input of a time of day corresponding to each of the improper input response setting values “1”, “2”, and “3” are arranged on the time of day input screen illustrated in FIG. 11. A “Confirm” key B301 that accepts confirmation of the contents input to the fields F301 to F303, and a “Cancel” key B302 that cancels input and returns to a previous screen or the like (for example, a function selection menu) are also arranged on the time of day input screen illustrated in FIG. 11. The “Confirm” key B301 is pressed after the contents illustrated in FIG. 11 have been input to the fields F301 to F303.

When the “Confirm” key B301 on the time of day input screen is pressed, the maintenance processor 12 of the controller 10 acquires the contents of the input improper input response setting values (time of day information for each setting value), registers this in the key settings information 21 of the data recording section 20 (S302), and then ends the processing.

The ATM 1 of the second exemplary embodiment registers the contents of the key settings information 21 in the manner described above.

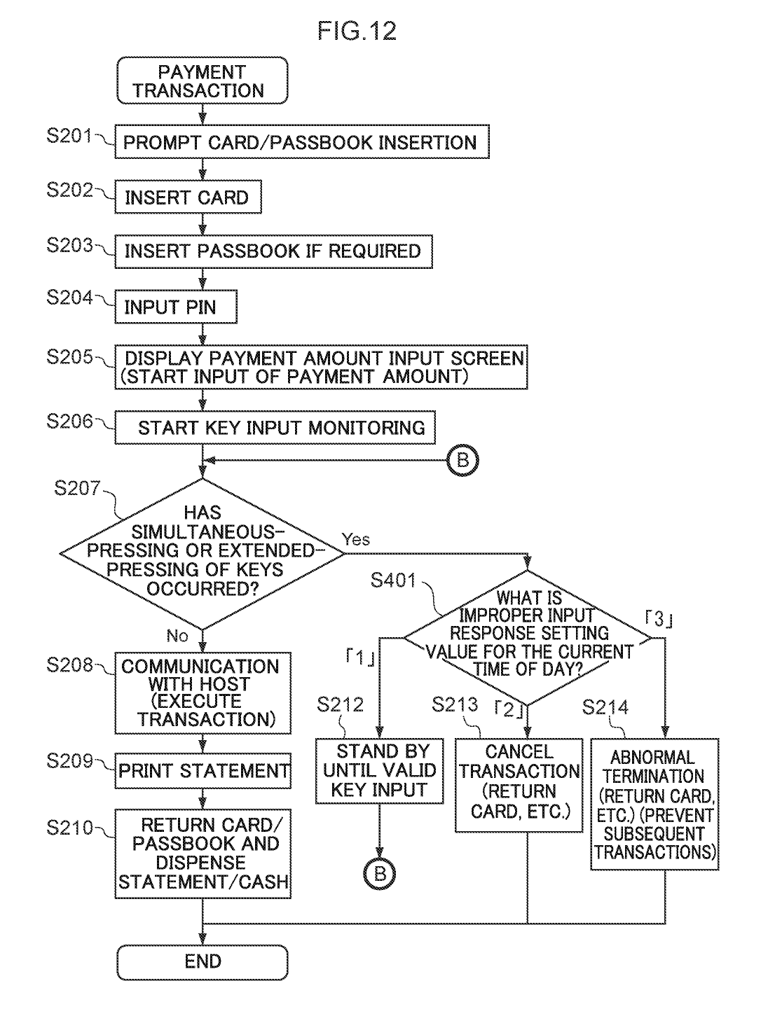

Next, explanation follows regarding an example of processing when the ATM 1 performs a customer transaction, with reference to the flowchart of FIG. 12. In the flowchart of FIG. 12, steps to perform processing similar to that in the flowchart of the first exemplary embodiment (the flowchart of FIG. 7, described above) are allocated the same step numbers (reference numerals). The following explanation concerns differences between the ATM 1 of the second exemplary embodiment and that of the first exemplary embodiment.

The ATM 1 of the second exemplary embodiment differs from that of the first exemplary embodiment in the point that step S211 is replaced by step S401.

As illustrated in FIG. 9 described above, the key settings information 21 of the second exemplary embodiment is set with a time of day for each setting value. At step S401, the controller 10 (transaction processor 11) of the second exemplary embodiment acquires the setting value corresponding to the current time in accordance with the contents of the key settings information 21. For example, consider a case in which the contents of the key settings information 21 are the contents illustrated in FIG. 9. If the current time were “10:00”, for example, the key settings information 21 would acquire “1” as the setting value corresponding to the current time.

When the controller 10 (transaction processor 11) of the second exemplary embodiment has acquired the settings through the processing of step S401 described above, the controller 10 (transaction processor 11) transitions to processing corresponding to the setting value (the processing of one of steps S212 to S214).

### (B-3) Advantageous Effects of the Second Exemplary Embodiment

The second exemplary embodiment is capable of exhibiting the following advantageous effects in addition to the advantageous effects of the first exemplary embodiment.

In the ATM 1 of the second exemplary embodiment, the ATM 1 enables registration of combinations of improper input response setting values and times of day. The ATM 1 of the second exemplary embodiment is thereby able to increase convenience and transaction safety (security) by enabling different improper input response setting values to be applied aligned with business hours.

### (C) Third Exemplary Embodiment

Detailed explanation follows regarding a third exemplary embodiment of a transaction device of the present invention, with reference to the drawings. In the following, explanation is given regarding an example in which a transaction device of the present invention is applied to an ATM.

### (C-1) Configuration of the Third Exemplary Embodiment

The configuration of an ATM 1 of the third exemplary embodiment can also be illustrated using FIG. 1, FIG. 2A, and FIG. 2B described above. The following explanation concerns differences between the ATM 1 of the third exemplary embodiment and that of the first exemplary embodiment.

The ATM 1 of the third exemplary embodiment differs from that of the first exemplary embodiment in the point that processing is performed so as to display an operation screen (also referred to below as an “improper input acknowledgement screen”) on the display and operation section 30 in order to notify the customer with information relating to the improper input (abnormal key operation) when improper input has occurred (for example, when simultaneous-pressing or extended-pressing of keys has occurred). Moreover, in the explanation of the ATM 1 of the third exemplary embodiment, it is possible to set whether or not to display the improper input acknowledgement screen (this is settable in the key settings information 21).

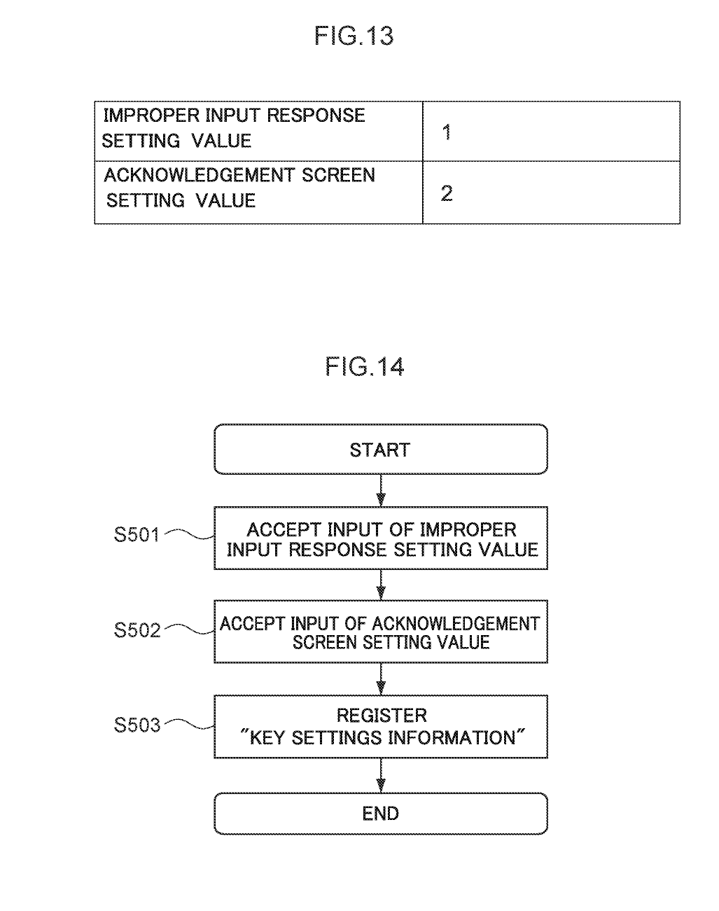

FIG. 13 is an explanatory diagram illustrating an example of configuration of the key settings information 21 according to the third exemplary embodiment.

In the ATM 1 of the third exemplary embodiment, the key settings information 21 is provided with an additional parameter (referred to below as a “acknowledgement screen setting value”) in order to set whether or not to display the improper input acknowledgement screen. The acknowledgement screen setting value can be set to either a value “1”, indicating that the improper input acknowledgement screen should not be displayed, or a value of “2”, indicating that the improper input acknowledgement screen should be displayed. Note that there is no limitation to the format used to register the acknowledgement screen setting value.

Note that the ATM 1 of the second exemplary embodiment may also be configured so as to display an improper input acknowledgement screen according to an acknowledgement screen setting value.

### (C-2) Operation of the Third Exemplary Embodiment

Next, explanation follows regarding operation of the ATM 1 of the third exemplary embodiment configured as described above.

First, explanation follows regarding operation when setting the key settings information 21 in the ATM 1 of the third exemplary embodiment, with reference to FIG. 14.

First, the staff operation section 100 of the ATM 1 accepts operation to select key settings from an operator. Accordingly, the controller 10 (maintenance processor 12) starts processing to accept key settings, and displays an improper input response setting value input screen on the staff operation section 100 in order to accept improper input response setting values (S501). Note that the processing of step S501 (the configuration of the improper input response setting value input screen and the like) is similar to that of the first exemplary embodiment (the processing of step S101 described above), and so detailed explanation thereof is omitted.

Next, the controller 10 (maintenance processor 12) displays an operation screen to accept the acknowledgement screen setting value (referred to below as the “acknowledgement screen setting value input screen”) on the staff operation section 100 (S502).

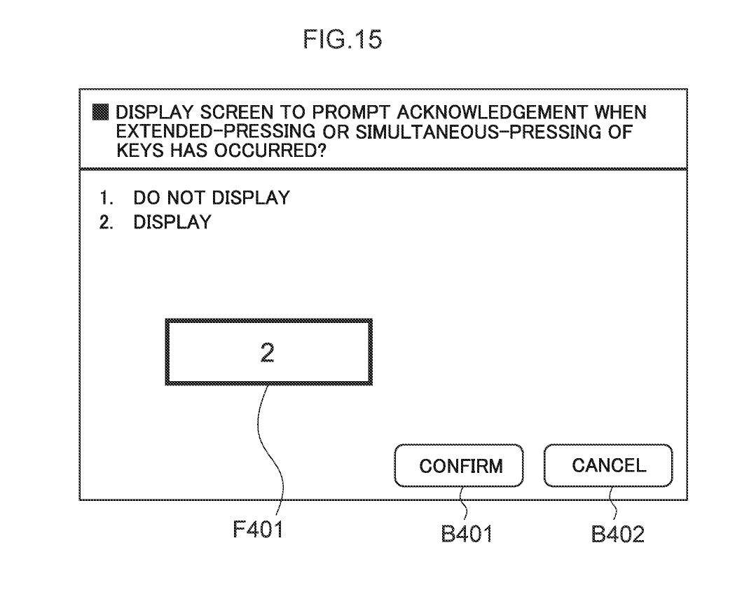

FIG. 15 is an explanatory diagram illustrating an example of configuration of the acknowledgement screen setting value input screen of the third exemplary embodiment.

A field F401 that accepts input of the acknowledgement screen setting value (“1” or “2”), a “Confirm” key B401 that accepts confirmation of the acknowledgement screen setting value input to the field F401, and a “Cancel” key B402 that cancels input of the acknowledgement screen setting value and returns to a previous screen or the like (for example, a function selection menu) are arranged on the acknowledgement screen setting value input screen illustrated in FIG. 15. The “Confirm” key B401 is pressed after the acknowledgement screen setting value has been input to the field F401 on the acknowledgement screen setting value input screen illustrated in FIG. 15.

When the “Confirm” key B401 on the acknowledgement screen setting value input screen is pressed, the maintenance processor 12 of the controller 10 registers each value that has been input (the improper input response setting value and the acknowledgement screen setting value) by registering in the key settings information 21 (S503), and then ends the processing.

The ATM 1 of the third exemplary embodiment registers the contents of the key settings information 21 in the manner described above.

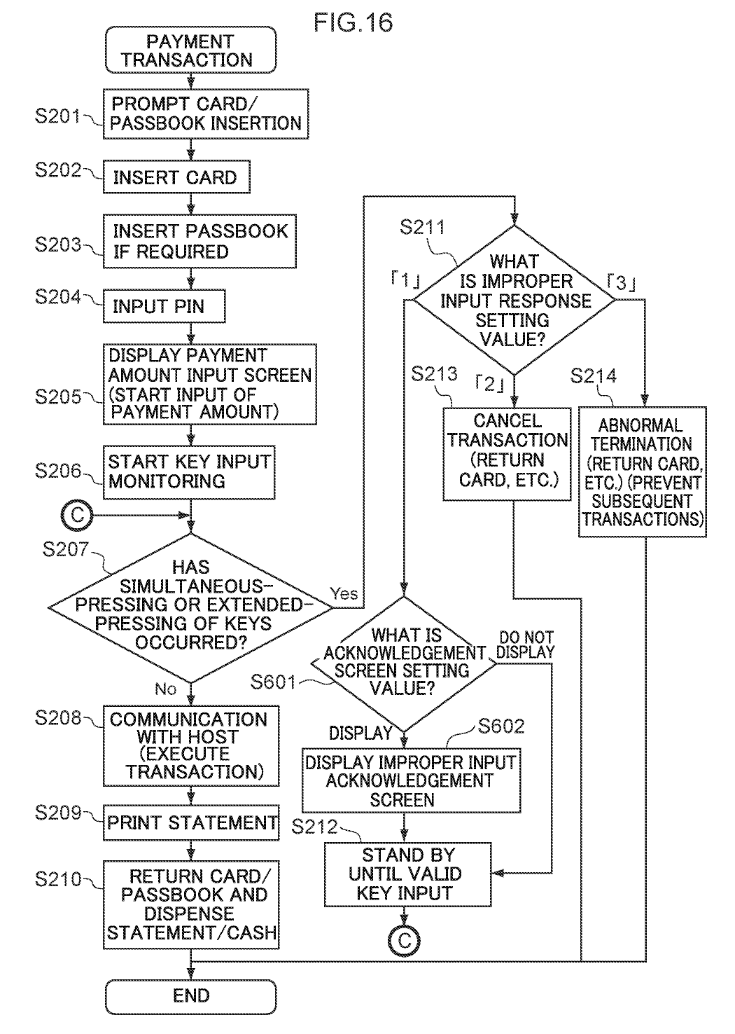

Next, explanation follows regarding an example of processing when the ATM 1 of the third exemplary embodiment performs a customer transaction, with reference to the flowchart of FIG. 16. In the flowchart of FIG. 16, steps to perform processing similar to that in the flowchart of the first exemplary embodiment (the flowchart of FIG. 7, described above) are allocated the same step numbers (reference numerals). The following explanation concerns differences between the ATM 1 of the third exemplary embodiment and that of the first exemplary embodiment.

The ATM 1 of the third exemplary embodiment differs to that of the first exemplary embodiment in the point that the processing of steps S601 and S602 is inserted prior to step S212, which is executed in cases in which the improper input response setting value is set to “1” in the first exemplary embodiment.

In cases in which the improper input response setting value has been confirmed as being “1” at step S211 described above, the controller 10 (transaction processor 11) of the third exemplary embodiment references the acknowledgement screen setting value of the key settings information 21 (S601).

In cases in which the acknowledgement screen setting value of the key settings information 21 is set to “1” (a setting not to display the improper input acknowledgement screen), the controller 10 (transaction processor 11) transitions to the processing of step S212 without displaying the improper input acknowledgement screen. In cases in which the acknowledgement screen setting value of the key settings information 21 is set to “2” (a setting to display the improper input acknowledgement screen), the controller 10 (transaction processor 11) displays the improper input acknowledgement screen on the staff operation section 100 (S602).

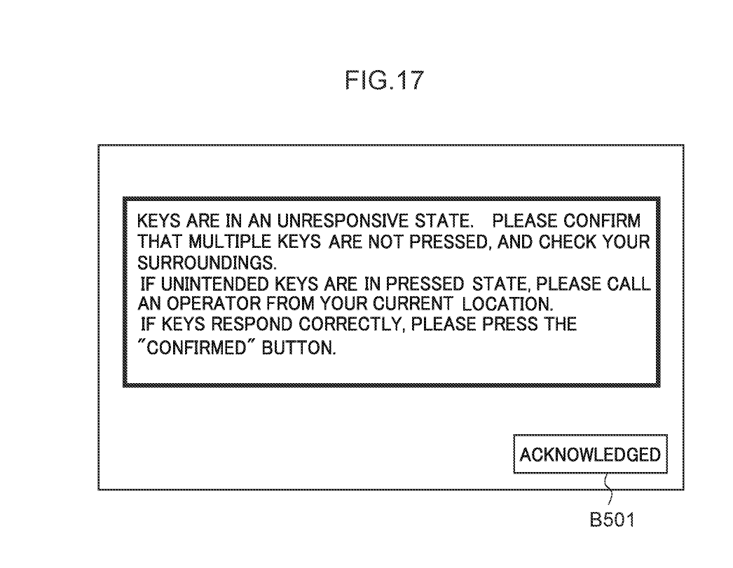

FIG. 17 is an explanatory diagram illustrating an example of configuration of the improper input acknowledgement screen.

A message to notify information relating to the improper input, and an “Acknowledged” key B501 that accepts confirmation from the customer are arranged on the improper input acknowledgement screen illustrated in FIG. 17. When the “Acknowledged” key B501 on the improper input acknowledgement screen is pressed, the controller 10 (transaction processor 11) transitions to the next processing (to the processing of step S212).

As illustrated in FIG. 17, to notify information relating to the improper input, a message, such as “Keys are in an unresponsive state. Please confirm that multiple keys are not pressed, and check your surroundings. If unintended keys are in pressed state, please call an operator from your current location. If keys respond correctly, please press the ‘Confirmed’ button”, is displayed on the improper input acknowledgement screen. In this manner, the improper input acknowledgement screen includes a message advising, for example, that improper input has occurred and prompting confirmation of the surrounding state to make sure that nothing is amiss.

### (C-3) Advantageous Effects of the Third Exemplary Embodiment

The third exemplary embodiment is capable of exhibiting the following advantageous effects in addition to the advantageous effects of the first exemplary embodiment.

The ATM 1 of the third exemplary embodiment displays the improper input acknowledgement screen when improper input has been detected. Accordingly, the ATM 1 of the third exemplary embodiment is able to improve the safety of customer transactions by notifying the customer that improper input has occurred and requiring customer acknowledgement.

### (D) Fourth Exemplary Embodiment

Detailed explanation follows regarding a fourth exemplary embodiment of a transaction device of the present invention, with reference to the drawings. In the following, explanation is given regarding an example in which a transaction device of the present invention is applied to an ATM.

### (D-1) Configuration of the Fourth Exemplary Embodiment

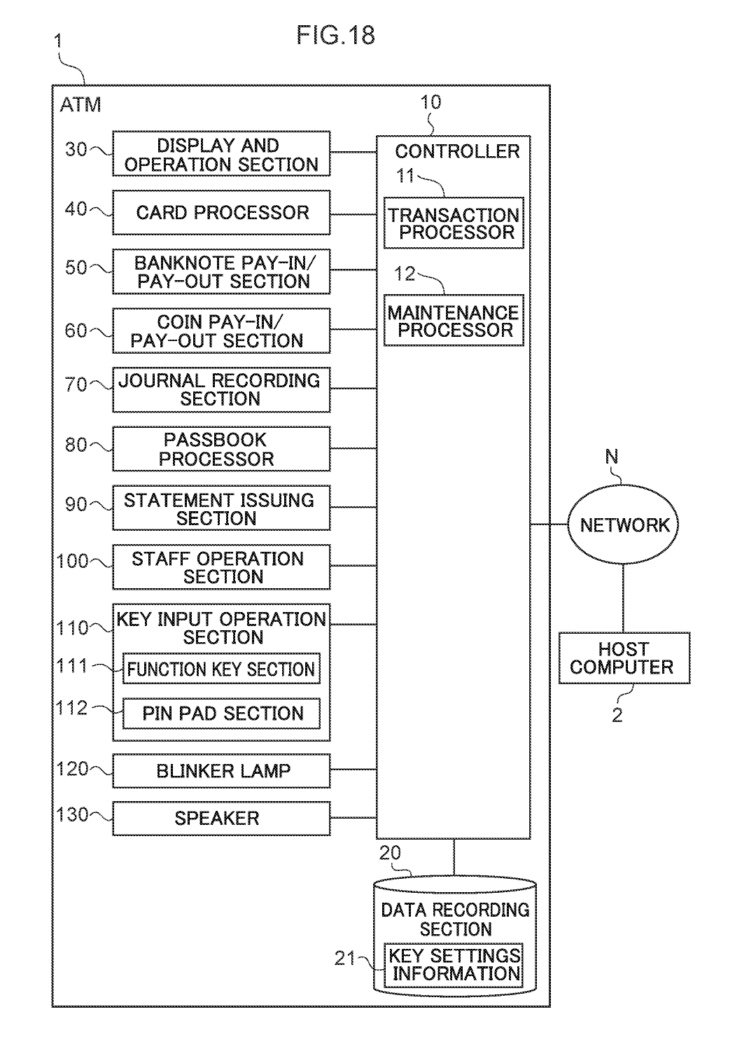

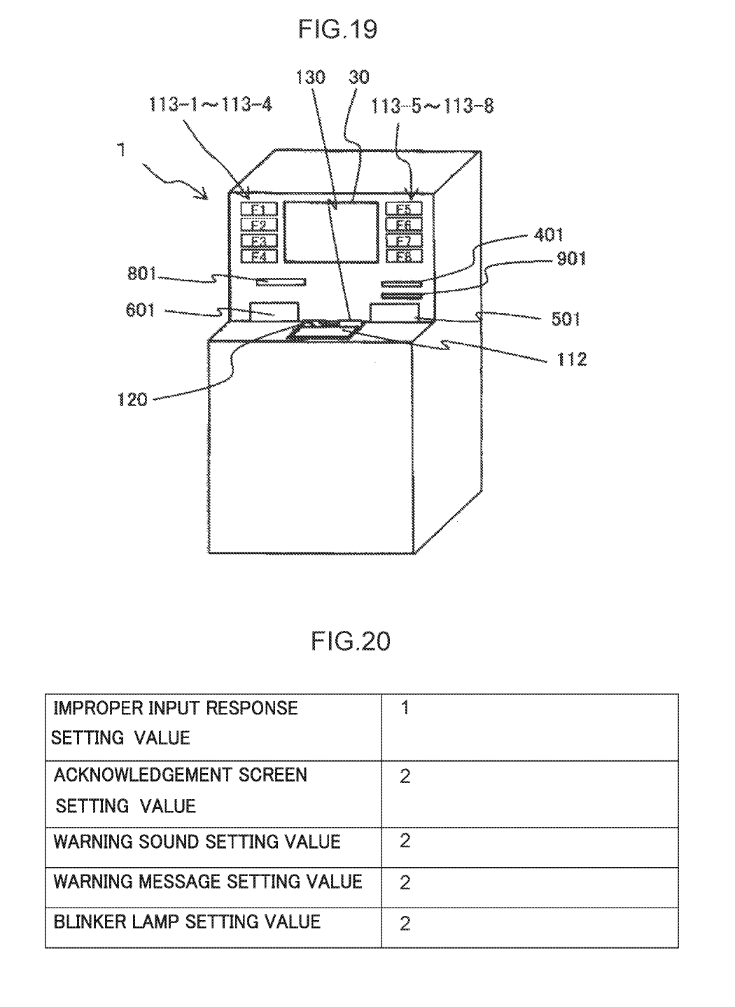

FIG. 18 is a block diagram illustrating functional configuration of an ATM 1 according to the fourth exemplary embodiment. FIG. 19 is a perspective view of the exterior of the ATM 1 according to the fourth exemplary embodiment.

As illustrated in FIG. 18 and FIG. 19, the ATM 1 of the fourth exemplary embodiment differs from that of the third exemplary embodiment in the point that a blinker lamp 120 (a lamp capable of flashing) and a speaker 130 are additionally provided.

As illustrated in FIG. 19, the blinker lamp 120 is disposed in the vicinity of the PIN pad section 112 and has a function of flashing so as to, for example, draw the customer's attention to the PIN pad section 112. The blinker lamp 120 operates so as to light up, flash, or the like under the control of the controller 10.

Moreover, as illustrated in FIG. 19, the speaker 130 is disposed in the vicinity of the PIN pad section 112, and has a function of emitting (playing) sound so as to, for example, draw the customer's attention to the PIN pad section 112. For example, the controller 10 (transaction processor 11) may output a sound from the speaker 130 based on an audio file (for example, a WAV format audio file (referred to as a WAVE file)) corresponding to a warning sound or a warning message (for example, a warning message relating to the improper input).

The ATM 1 of the fourth exemplary embodiment differs from that of the third exemplary embodiment in the point that, when improper input has occurred (for example, when simultaneous-pressing or extended-pressing of keys has occurred), other output processing is able to be executed in addition to displaying the improper input acknowledgement screen.

Specifically, the controller 10 (transaction processor 11) of the fourth exemplary embodiment is capable of playing a warning sound from the speaker 130, playing a warning message from the speaker 130, flashing the blinker lamp 120, and so on when improper input has occurred, in accordance with respective settings (for example, settings in the key settings information 21).

FIG. 20 is an explanatory diagram illustrating an example of configuration of the key settings information 21 according to the fourth exemplary embodiment.

In the key settings information 21 of the fourth exemplary embodiment, a parameter for setting whether or not to play a warning sound from the speaker 130 (referred to below as the “warning sound setting value”) has been added to the key settings information 21. The warning sound setting value can be set to either a value of “1”, indicating that the warning sound setting value should not be played, or a value of “2”, indicating that the warning sound should be played. Note that there is no limitation to the format used to register the warning sound setting value.

Moreover, in the key settings information 21 of the fourth exemplary embodiment, a parameter for setting whether or not to play a warning message from the speaker 130 (referred to below as the “warning message setting value”) has been added to the key settings information 21. The warning message setting value can be set to either a value of “1”, indicating that the warning message should not be played, or a value of “2”, indicating that the warning message should be played. Note that there is no limitation to the format used to register the warning message setting value.

Moreover, in the key settings information 21 of the fourth exemplary embodiment, a parameter for setting whether or not to flash the blinker lamp 120 (referred to below as the “blinker lamp setting value”) has been added to the key settings information 21. The blinker lamp setting value can be set to either a value of “1”, indicating that the blinker lamp 120 should not be flashed, or a value of “2”, indicating that the blinker lamp 120 should be flashed. Note that there is no limitation to the format used to register the blinker lamp setting value.

Note that in the ATM 1 of the fourth exemplary embodiment, as described above, when improper input has occurred, the four actions of displaying the improper input acknowledgement screen, playing a warning sound from the speaker 130, playing a warning message from the speaker 130, and flashing the blinker lamp 120 are enabled according to the settings. However, configuration may be made in which only some of these actions are applied, or are applied in combination with other actions.

### (D-2) Operation of the Fourth Exemplary Embodiment

Next, explanation follows regarding operation of the ATM 1 of the fourth exemplary embodiment configured as described above.

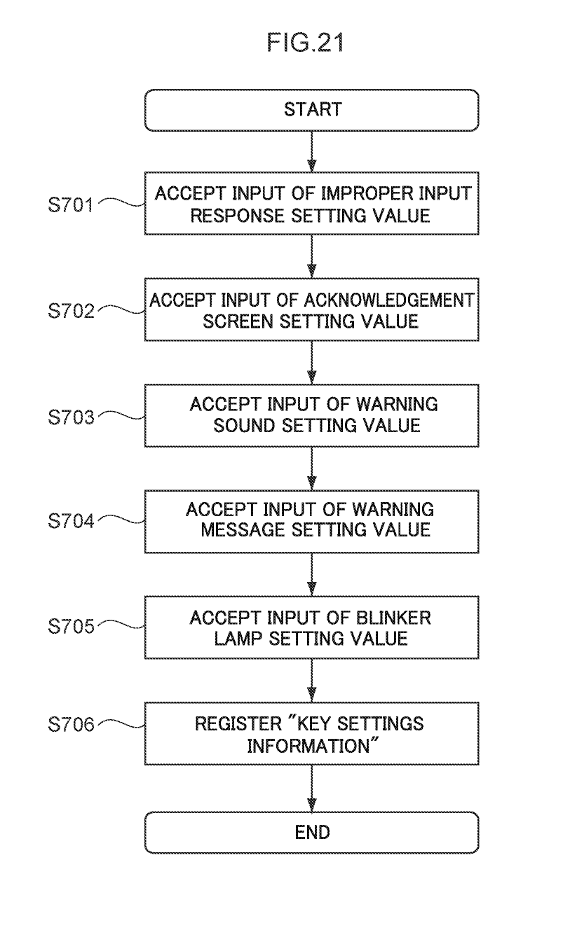

First, explanation follows regarding operation when setting the key settings information 21 in the ATM 1 of the fourth exemplary embodiment, with reference to FIG. 21.

First, the staff operation section 100 of the ATM 1 accepts operation from an operator to select key settings. Accordingly, the controller 10 (maintenance processor 12) starts processing to accept the key settings, and displays an improper input response setting value input screen on the staff operation section 100 in order to receive improper input response setting values (S701). Note that the processing of step S701 (the configuration of the improper input response setting value input screen and the like) is similar to that of the first exemplary embodiment (the processing of step S101 described above), and so detailed explanation thereof is omitted.

Next, the controller 10 (maintenance processor 12) displays an acknowledgement screen setting value input screen to receive the acknowledgement screen setting value on the staff operation section 100, and accepts input of the acknowledgement screen setting value (S702). Note that the processing to display the acknowledgement screen setting value input screen on the staff operation section 100 and accept input of the acknowledgement screen setting value is similar to that of step S502 described above, and so detailed explanation thereof is omitted.

Next, the controller 10 (maintenance processor 12) displays an operation screen to receive the warning sound setting value (referred to below as the “warning sound setting value input screen”) on the staff operation section 100, and accepts input of the warning sound setting value (S703).

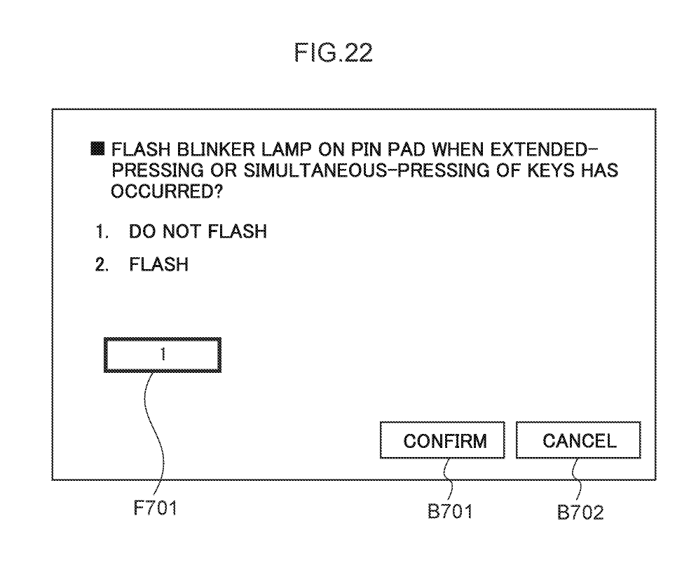

FIG. 22 is an explanatory diagram illustrating an example of configuration of the warning sound setting value input screen of the fourth exemplary embodiment.

A field F501 that accepts input of the warning sound setting value (“1” or “2”), a “Acknowledged” key B501 that accepts confirmation of the warning sound setting value input to the field F501, and a “Cancel” key B502 that cancels input of the warning sound setting value and returns to a previous screen or the like (for example, a function selection menu) are arranged on the warning sound setting value input screen illustrated in FIG. 22. The “Acknowledged” key B501 is pressed after the warning sound setting value has been input to the field F501 on the warning sound setting value input screen illustrated in FIG. 22.

Next, the controller 10 (maintenance processor 12) displays an operation screen to receive the warning message setting value (referred to below as the “warning message setting value input screen”) on the staff operation section 100, and accepts input of the warning message setting value (S704).

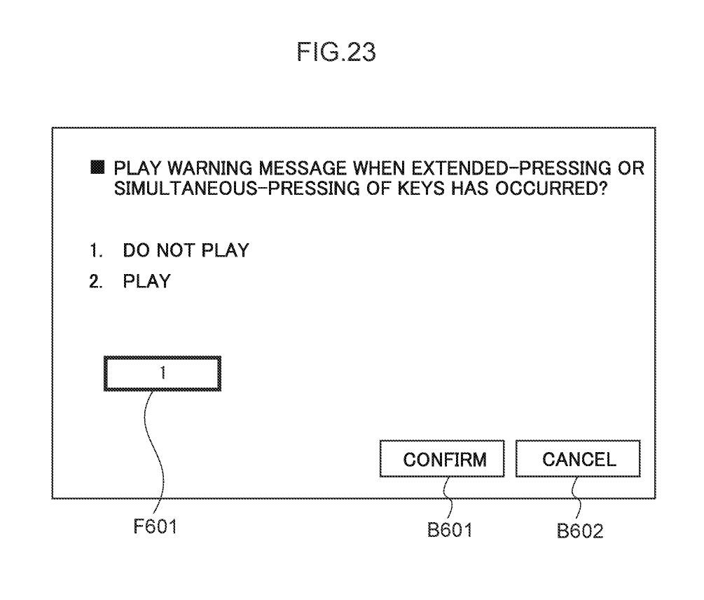

FIG. 23 is an explanatory diagram illustrating an example of configuration of the warning message setting value input screen of the fourth exemplary embodiment.

A field F601 that accepts input of the warning message setting value (“1” or “2”), a “Confirm” key B601 that accepts confirmation of the warning message setting value input to the field F601, and a “Cancel” key B602 that cancels input of the warning message setting value and returns to a previous screen or the like (for example, a function selection menu) are arranged on the warning message setting value input screen illustrated in FIG. 23. The “Confirm” key B601 is pressed after the warning message setting value has been input to the field F601 on the warning message setting value input screen illustrated in FIG. 23.

Next, the controller 10 (maintenance processor 12) displays an operation screen to receive the blinker lamp setting value (referred to below as the “blinker lamp setting value input screen”) on the staff operation section 100, and accepts input of the blinker lamp setting value (S705).

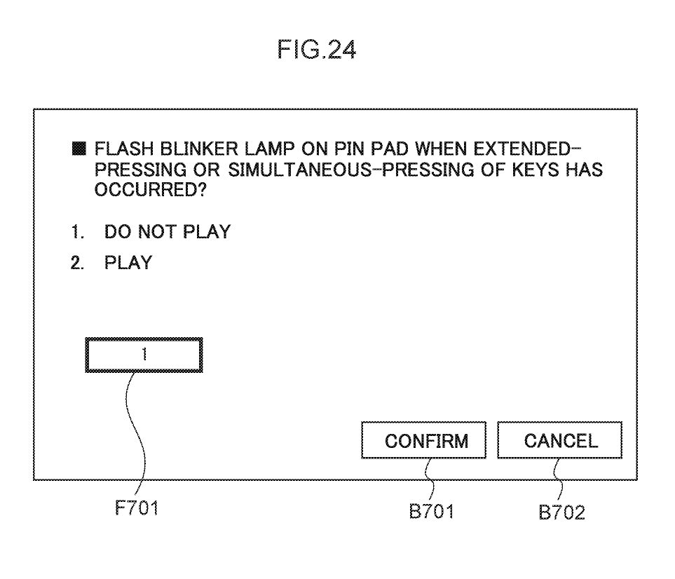

FIG. 24 is an explanatory diagram illustrating an example of configuration of the blinker lamp setting value input screen of the fourth exemplary embodiment.

A field F701 that accepts input of the blinker lamp setting value (“1” or “2”), a “Confirm” key B701 that accepts confirmation of the blinker lamp setting value input to the field F701, and a “Cancel” key B702 that cancels input of the blinker lamp setting value and returns to a previous screen or the like (for example, a function selection menu) are arranged on the blinker lamp setting value input screen illustrated in FIG. 24. The “Confirm” key B701 is pressed after the blinker lamp setting value has been input to the field F701 on the blinker lamp setting value input screen illustrated in FIG. 24.

Next, the maintenance processor 12 of the controller 10 registers each value that has been input (the improper input response setting value, the acknowledgement screen setting value, the warning sound setting value, the warning message setting value, and the blinker lamp setting value) by registering in the key settings information 21 (S706), and then ends the processing.

The ATM 1 of the fourth exemplary embodiment registers the contents of the key settings information 21 in the manner described above.

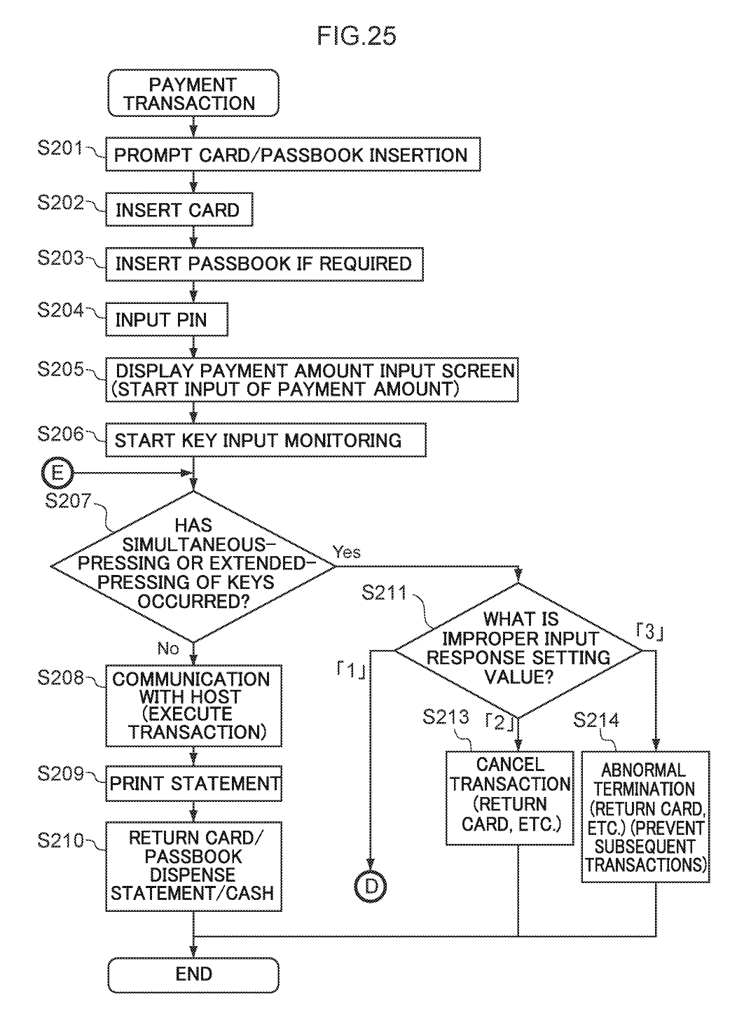

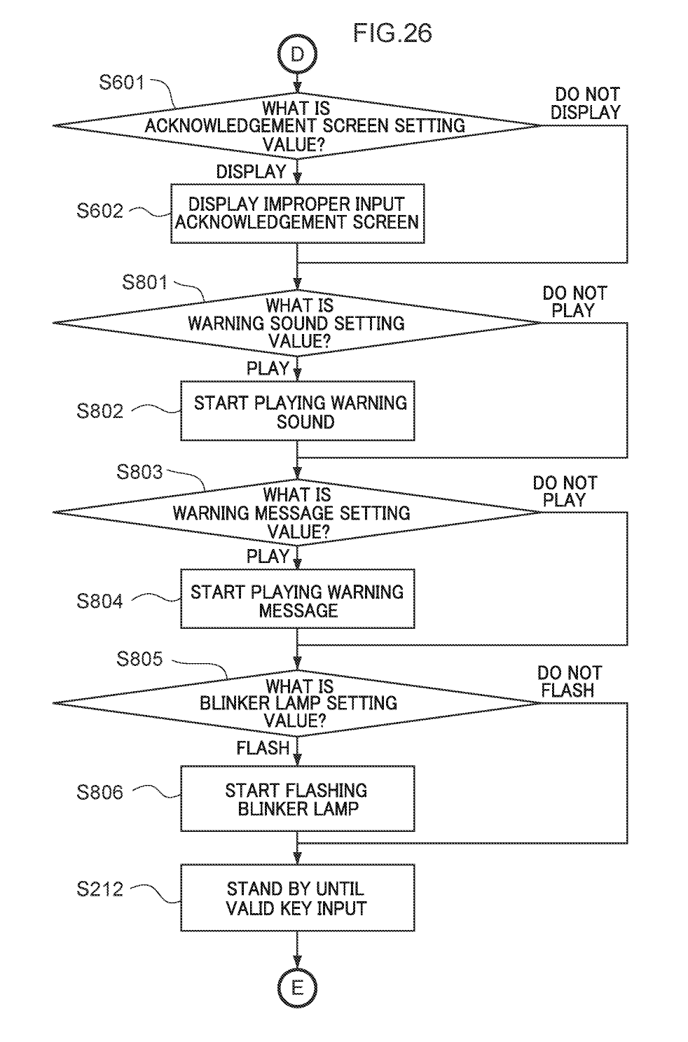

Next, explanation follows regarding an example of processing when the ATM 1 of the fourth exemplary embodiment performs a customer transaction, with reference to the flowcharts of FIG. 25 and FIG. 26. In the flowcharts of FIG. 25 and FIG. 26, steps to perform processing similar to that in the flowchart of the third exemplary embodiment (the flowchart of FIG. 12, described above) are allocated the same step numbers (reference numerals). The following explanation concerns differences between the ATM 1 of the fourth exemplary embodiment and that of the third exemplary embodiment.

The ATM 1 of the fourth exemplary embodiment differs from that of the third exemplary embodiment in the point that steps S801 to S806 are inserted after the processing of steps S212, S601, and S602 executed in cases in which the improper input response setting value is “1” in the third exemplary embodiment. The following explanation primarily concerns processing (S601, S60, and S801 to S806) executed in cases in which the improper input response setting value illustrated in FIG. 26 is “1”.

In cases in which the improper input response setting value has been confirmed as being “1” at step S211 described above, the controller 10 (transaction processor 11) of the fourth exemplary embodiment references the acknowledgement screen setting value of the key settings information 21 (S601).

In cases in which the acknowledgement screen setting value of the key settings information 21 is set to “1” (a setting not to display the improper input acknowledgement screen), the controller 10 (transaction processor 11) transitions to the processing of step S801, described later, without displaying the improper input acknowledgement screen. In cases in which the acknowledgement screen setting value of the key settings information 21 is set to “2” (a setting to display the improper input acknowledgement screen), the controller 10 (transaction processor 11) starts display of the improper input acknowledgement screen on the staff operation section 100 (S602), and then transitions to the processing of step S801, described later. Note that the improper input acknowledgement screen is similar to that in FIG. 17, described above, and so detailed explanation thereof is omitted.

On transition to step S801, the controller 10 (transaction processor 11) references the warning sound setting value of the key settings information 21.

In cases in which the warning sound setting value of the key settings information 21 is set to “1” (a setting not to play the warning sound), the controller 10 (transaction processor 11) transitions to the processing of step S803, described later, without playing the warning sound. In cases in which the warning sound setting value of the key settings information 21 is set to “2” (a setting to play the warning sound), the controller 10 (transaction processor 11) starts playing the warning sound on the speaker 130 (S802), and then transitions to the processing of step S803, described later. For example, the controller 10 (transaction processor 11) outputs a sound based on an audio file (such as a Wave file) corresponding to the warning sound from the speaker 130. There is no limitation to the content of the warning sound, and various warning sounds may be applied (for example various alarm sounds output when displaying an error on a computer).

On transition to step S803, the controller 10 (transaction processor 11) references the warning message setting value of the key settings information 21.

In cases in which the warning message setting value of the key settings information 21 is set to “1” (a setting not to play the warning message), the controller 10 (transaction processor 11) transitions to the processing of step S805, described later, without playing the warning message. In cases in which the warning message setting value of the key settings information 21 is set to “2” (a setting to play the warning message), the controller 10 (transaction processor 11) starts playing the warning message on the speaker 130 (S804), and then transitions to the processing of step S805, described later. For example, the controller 10 (transaction processor 11) outputs a sound based on an audio file (such as a Wave file), corresponding to the warning message, from the speaker 130. The content of the warning message is not limited, and the warning message may, for example, be the message displayed on the acknowledgement screen illustrated in FIG. 17.

On transition to step S805, the controller 10 (transaction processor 11) references the blinker lamp setting value of the key settings information 21.

In cases in which the blinker lamp setting value of the key settings information 21 is set to “1” (a setting not to flash the blinker lamp 120), the controller 10 (transaction processor 11) transitions to the processing of step S212 without flashing the blinker lamp 120. In cases in which the blinker lamp setting value of the key settings information 21 is set to “2” (a setting to flash the blinker lamp 120), the controller 10 (transaction processor 11) starts flashing the blinker lamp 120 (S806), and then transitions to the processing of step S212.

On transition to step S212, the controller 10 (transaction processor 11) stands by without doing anything until the improper input has been released (for example, until the simultaneous-pressing state or the extended-pressing state has been released), and then transitions to step S207 after the improper input has been released. Note that when improper input is released, the controller 10 (transaction processor 11) may transition to step S207 after stopping each action executed accompanying the improper input (display of the improper input acknowledgement screen, playing the warning sound, playing the warning message, and flashing the blinker lamp 120).

### (D-3) Advantageous Effects of the Fourth Exemplary Embodiment

The fourth exemplary embodiment is capable of exhibiting the following advantageous effects in addition to the advantageous effects of the third exemplary embodiment.

The ATM 1 of the fourth exemplary embodiment responds with various actions (playing the warning sound from the speaker 130, playing the warning message from the speaker 130, and flashing the blinker lamp 120) in addition to the improper input acknowledgement screen in accordance with relevant settings when improper input has occurred. Accordingly, the ATM 1 of the fourth exemplary embodiment is capable of more reliably making a customer aware that improper input has occurred than the third exemplary embodiment, and a reduction in fraudulent payment transactions may be expected.

The ATM 1 of the fourth exemplary embodiment enables actions performed when improper input has occurred to be set flexibly according to the setting contents of the key settings information 21, thereby increasing convenience.

Moreover, the ATM of the fourth exemplary embodiment performs output using the blinker lamp 120 and the speaker 130 when improper input has occurred, such that attention can be drawn to the surroundings, and therefore a reduction in fraudulent payment transactions may be expected.

### (E) Other Exemplary Embodiments

The present invention is not limited to the respective exemplary embodiments described above, and modified embodiments such as the below may be applied.

(E-1) In the ATM 1 of each of the exemplary embodiments described above, an input section that accepts input from a customer is configured including the display and operation section 30 that is capable of displaying operation screens having on-screen keys, and the key input operation section 110 that is configured by physical keys. However, the key input operation section 110 may be omitted such that all of the keys of the input section are configured by on-screen keys.

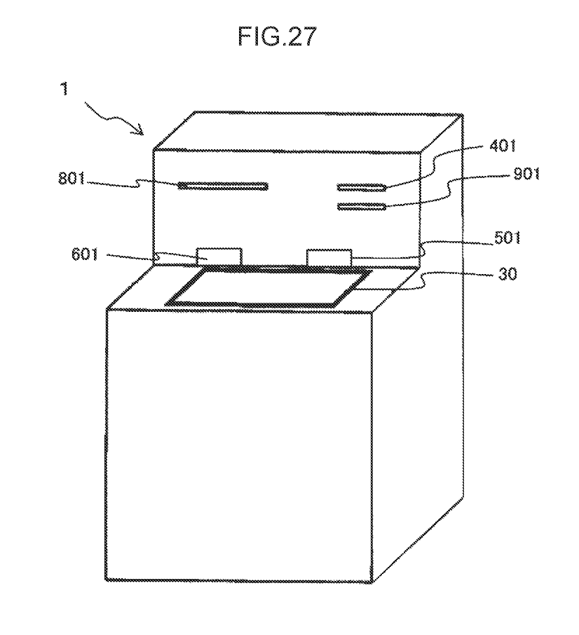

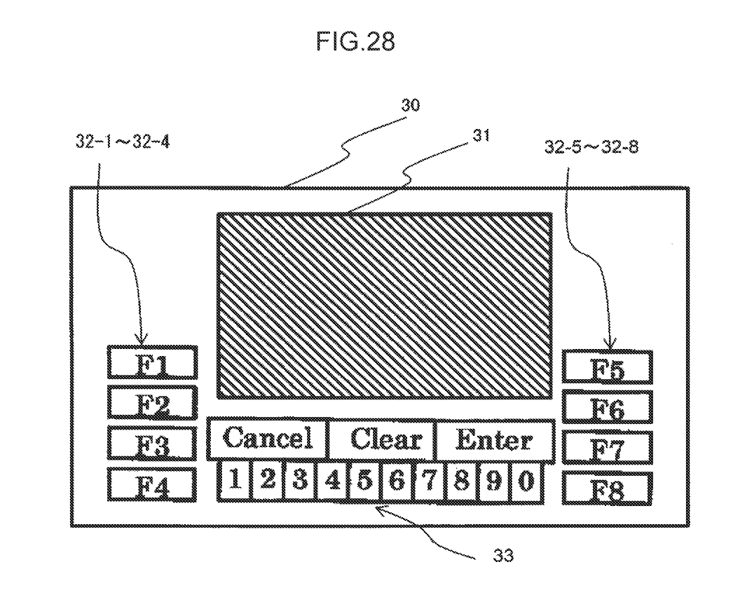

For example, the key input operation section 110 (the function key section 111 and the PIN pad section 112) are omitted from the ATM 1A illustrated in FIG. 27. Instead, the size of the display and operation section 30 of the ATM 1A is increased, and as illustrated in FIG. 28, configuration may be made such that all of the omitted physical keys are displayable as on-screen keys. In the display and operation section 30 illustrated in FIG. 28, eight function keys 31-1 to 32-8 configured by on-screen keys, and a PIN pad 33 configured by on-screen keys, are arranged in the vicinity of a region 31 that displays operation screens. The controller 10 (transaction processor 11) of the ATM 1A is capable of detecting extended-pressing states and simultaneous-pressing states of the on-screen keys arranged on the display and operation section 30.

(E-2) In each of the exemplary embodiments described above, explanation has been given regarding an example in which a transaction device of the present invention is applied to an Automatic Teller Machine (ATM). However, the transaction device of the present invention may also be applied to other devices, such as vending machines or automatic ticketing machines.

(E-3) In each of the exemplary embodiments described above, explanation has been given regarding an example in which the controller 10 (transaction processor 11) monitors for both extended-pressing states and simultaneous-pressing states. However, configuration may be made in which the controller 10 (transaction processor 11) only monitors for one of these states.

The disclosure of Japanese Patent Application No. 2015-146959 is incorporated in its entirety by reference herein.

All cited documents, patent applications, and technical standards mentioned in the present specification are incorporated by reference in the present specification to the same extent as if each cited document, patent application, or technical standard was specifically and individually indicated to be incorporated by reference.

1. A transaction device comprising:
an input section including a plurality of keys;
a determination means that monitors for at least one out of a simultaneous-pressing state in which a plurality of the keys are pressed at the same time or an extended-pressing state in which one of the keys is pressed continuously for a predetermined duration or longer, and that determines that improper input has been performed in cases in which either a simultaneous-pressing state or an extended-pressing state has been detected;
a recording section that records setting information indicating processing contents for cases in which the determination means has determined that improper input has been performed; and
a transaction processing means that performs transaction processing with a customer using the input section, and that performs an action according to setting information recorded in the recording section in cases in which the determination means has determined that improper input has been performed.

2. The transaction device of claim 1, further comprising a setting changing means that receives changes to setting information of the recording section.

3. The transaction device of claim 1, wherein the setting information is set with an improper input response setting value corresponding to processing content for cases in which the determination means has determined that improper input has been performed.

4. The transaction device of claim 1, wherein the setting information is set with a combination of an improper input response setting value corresponding to processing content for cases in which the determination means has determined that improper input has been performed, and a time period for application of the improper input response setting value.

5. The transaction device of claim 4, wherein the improper input response setting value is a value corresponding to one action out of a first action to disable input using the keys of the input section, a second action to end a transaction that is currently underway, and a third action to stop accepting transactions as if an abnormality had arisen.

6. The transaction device of claim 1, further comprising a display section that displays transaction-related information to a customer, and wherein
the transaction processing means outputs, on the display section, information prompting acknowledgement relating to improper input in cases in which the determination means has determined that improper input has been performed.

7. The transaction device of claim 1, further comprising a speaker, and wherein
the transaction processing means outputs a warning sound from the speaker in cases in which the determination means has determined that improper input has been performed.

8. The transaction device of claim 1, further comprising a speaker, and wherein
the transaction processing means outputs, from the speaker, audio of a warning message relating to improper input in cases in which the determination means has determined that improper input has been performed.

9. The transaction device of claim 1, further comprising a blinker lamp, and wherein
the transaction processing means flashes the blinker lamp in cases in which the determination means has determined that improper input has been performed.

10. The transaction device of claim 3, wherein the improper input response setting value is a value corresponding to one action out of a first action to disable input using the keys of the input section, a second action to end a transaction that is currently underway, and a third action to stop accepting transactions as if an abnormality had arisen.
